(19) United States
(12) Patent Application Publication
(10) Pub. No.: US 2009/0192657 A1
(43) Pub. Date: Jul. 30, 2009

(54) METHOD FOR CONTROLLING A HOUSEHOLD COOKING APPLIANCE USING A TIMER

(75) Inventor: Wilhelm Heicks, Geislingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Control Systems GmbH

(21) Appl. No.: 12/361,010

(22) Filed: Jan. 28, 2009

(30) Foreign Application Priority Data
Jan. 28, 2008 (DE) 10 2008 008 084.5

(51) Int. Cl. H01H 43/02; G04B 47/00; H05B 1/02

(52) U.S. Cl. 700/306; 368/10; 219/492

(57) ABSTRACT

Described herein is a method for controlling a baking oven using a timer module, said timer module comprising a timer relay, a switch for operating mode selection, and a switch for setting a heating temperature or a heating power. The timer relay is serially connected into a power supply line to a heating device of the baking oven, whereby following the activation of a first safety lock function on the timer module by a special user function, a timer setting is locked against change. When the timer setting is locked thus, a baking oven operating cycle that has been pre-specified by a user by timer adjustment proceeds as specified and, thereafter, the heating device is switched off by opening the timer relay. Then, the timer relay can be reactivated only by an additional special user function on the timer module.

### CROSS REFERENCE TO RELATED APPLICATIONS

This application claims priority to German Application Number 10 2008 008 084.5, filed on Jan. 28, 2008, the contents of which are incorporated by reference.

### FIELD OF USE

The invention describes a method for controlling an electrical cooking appliance comprising a heating device and a timer module as well as a timer module designed for carrying out this method.

### BACKGROUND

It is known from EP 1 344 981 A, for example, to integrate a manually actuatable safety element as a switch in a cooking field in order to lock a baking oven heating device against unauthorized use. In a similar way, such a switch or another safety element can also be used to lock a cooking field heating device.

EP 1 600 694 A discloses a timer for a household appliance for setting a time-controlled operation, for example, of a cooking field. With this device, following the activation of a child safety feature, the household appliance can be protected against unauthorized use, whereby, with the child safety feature activated, only a time, a duration of the process, or a duration of operation can be set.

In accordance with EP 859 296 A, a selected or set washing program in a washing machine is protected against unauthorized change by third parties in that a safety feature is provided. Consequently, it is impossible to change anything at all.

### BRIEF DESCRIPTION OF THE DRAWINGS

The drawings show a schematic illustration of an example of embodiment of the invention and will be explained in detail hereinafter.

FIG. 1 illustrates an elementary diagram of a timer module in accordance with one embodiment of the invention, said timer module being provided on an electrical cooking appliance with several heating devices;

FIG. 2 is an exploded diagram of the timer module as a component; and,

FIG. 3 illustrates the timer module with control elements that are to be integrated as a complete module.

### DETAILED DESCRIPTION

An object of the invention is to provide a method as well as a timer module suitable for carrying out this method, whereby these can be used to solve the problems of prior art, and to provide, activate and again deactivate, in a particularly advantageous manner, a safety lock function on an electrical cooking appliance comprising a heating device.

This object is achieved in one embodiment, with a method displaying the features of Claim 1 or 2, as well as with a timer module displaying the features of Claim 14. Advantageous as well as preferred embodiments of the invention are the subject matter of additional claims and are explained in detail hereinafter. Some of the features will only be described separately for one of the two methods or for the timer module. However, independently thereof, they are to be applicable to each and every embodiment. The wording of the claims is chosen with expressed reference to the content of the description.

In a first basic embodiment of the method, the electrical cooking appliance which, particularly advantageously, is a baking oven, comprises a timer module with a timer relay, a switch for mode selection, and a switch for adjusting a heating temperature or a heating power. The timer relay is serially connected into a power supply line to the heating device of the electrical cooking appliance. In accordance with one embodiment of the invention, upon activating a first safety lock function on the timer module by a special user function that will be described in detail hereinafter, a timer setting is locked against change. This means that an operating cycle of the electrical cooking appliance that is pre-specified by the user in the timer module via the respective timer setting takes place as intended, i.e., for example, said operating cycle starts after a pre-specified time and stops again after a pre-specified time. After the pre-specified operating cycle of the electrical cooking appliance, the heating device or, under certain circumstances, even the entire electrical cooking appliance is switched off by opening the timer relay, so that then an operation of the heating device or the electrical cooking appliance is no longer possible without at least one further step. In order to allow the operation to restart the timer relay must first be closed again, which is only possible via an additional or the same special user function on the timer module.

Consequently, a type of child safety feature is achieved which means that following the activation of this described first safety lock function, the timer setting is locked against change, so that the times of the timer cannot be changed, i.e., the times cannot be either be shortened nor lengthened. In particular, when the electrical cooking appliance comprises mechanical switches for the selection of the mode of operation and power, these can still be changed even when the first safety lock function has been activated, however, it is not possible to change the timer setting as such. Consequently, in accordance with a first aspect of the invention, this first safety lock function is a type of lock for the timer module itself. In accordance with a second aspect, said safety lock function inevitably causes a locking or deactivation of the heating device of the electrical cooking appliance at the end of the operating cycle of the electrical cooking appliance. To do so, the timer relay is opened which can no longer be opened by the locked timer module, unless the timer module is again unlocked beforehand by a special user function, as it were.

In a second basic embodiment of the method, where, differently from the first embodiment, a timer setting has not been performed as of yet or where no operating cycle of the cooking appliance has been pre-specified as of yet, the timer relay is opened immediately by a special user function after a second safety lock function on the timer module had been activated. Consequently, an operation of the heating device or even of the entire electrical cooking appliance is prevented completely. In this case, too, the timer relay can only be activated or closed by an additional special user function on the timer module. This second basic embodiment of the invention thus covers the case that nothing has been adjusted on the timer module just yet. If the timer module is then locked, as it were, it is not only not possible to change the timer module itself, but the heating device or the electrical cooking appliance are locked or deactivated at the same time, so to speak. Consequently, for use as a type of child safety feature or security against unauthorized use, it is possible to achieve locking with the activated second lock function for most of the time, as it were, as in this case where no operation whatsoever is possible, i.e., maximum safety or security is achieved. Another special user function reverses the safety lock function for normal operation of the electric cooking appliance or for setting a timer for timer mode of the electrical cooking appliance.

Consequently, together with the two embodiments of the invention, a very good possibility for a safety lock function or for locking a heating device or the entire electrical cooking appliance to prevent unauthorized use is being provided overall. Another good safety function can be achieved, above all, by adapting to the circumstance that although it is not possible to lock the adjustment of the mechanical switches for operation mode selection and for the operating power of the cooking appliance, it is, however, possible to at least lock a pre-specified maximum duration of operation.

In accordance with another embodiment of the invention, the timer relay must be closed or activated again by reversing or deactivating the safety lock function. This is basically known from prior art, but can be achieved by different user functions, such as the simultaneous actuation of several control elements, the sequential actuation of several control elements in an exactly pre-specified sequence, or a long-lasting actuation of at least one of the control elements. Upon renewed closing of the timer relay, the electrical cooking appliance can again be operated in any desired mode of operation.

Advantageously, the first and the second safety lock functions can be activated on the timer module in the same manner, by the same activation, or by the same special user function. Whether or not the first or the second safety lock function is activated depends only on whether a timer operation has already been pre-specified or not. This means that the first safety lock function is activated after the special user function when a timer operation has been pre-specified. Other than that, the second safety lock function is activated, i.e., the heating device or the electrical cooking appliance is fully locked.

As has been previously explained, the first safety lock function secures only a time function against change or readjustment, said time function being set in the timer module. Consequently, this means that only the timer mode continues as set and can no longer be changed. In case nothing has been set yet in the timer module, the second safety lock functions to then advantageously secure the heating device or the entire electrical cooking appliance against being switched on.

Advantageously, it is possible to display—on the timer module or on the electrical cooking appliance—when a safety lock function has been activated. It is possible to indicate which of the two different safety functions is activated. This differentiation may also be omitted, for example, when simply only one type of safety symbol is displayed. For example, it is possible to provide an illuminated display with a correspondingly recognizable symbol. This display may be provided, in general, on the electrical cooking appliance. However, it is viewed as being advantageous if it is provided on the timer module. Likewise, the timer module may be configured as a stand-alone module which itself comprises or performs all the functions implemented in or effected by it.

In another embodiment of the invention, it is possible that the safety lock function is automatically activated as a child safety feature or locking feature when the electrical cooking appliance is connected to the power supply for the first time. Furthermore, it is also possible to provide that, for example, in the case of a power failure, the safety lock function, preferably, the second safety lock function is activated in order to thus directly obtain a type of child safety lock. This feature prevents the safety lock function, which normally would be activated, from being deactivated or omitted due to the power failure and the electrical cooking appliance from being unsecured.

In particular, the method is suitable for the operation of a baking oven as electrical cooking appliance. Such a baking oven may comprise a pyrolysis function in order to clean a baking oven chamber by super-heating with a baking oven heating device being the heating device. For this function, the timer module may comprise a locking relay which locks a door lock on the baking oven chamber for the duration of the pyrolysis mode so that the baking oven chamber cannot be opened. In this case, the timer module thus comprises the timer relay as well as the previously mentioned locking relay.

Advantageously, it is possible to provide the timer module with another input connector for a temperature sensor that is located in the baking oven chamber. Through this input connector, the temperature sensor allows the deactivation of the door lock that locks by means of the locking relay, for example, for the previously described pyrolysis at very high temperatures, when the temperature in the baking oven chamber drops again below a temperature considered to be too dangerous for opening. As a result of this, it is achieved that the baking oven chamber can only be opened by a user when no danger exists of receiving burns.

The timer module in accordance with one aspect of the invention is characterized in that it is a stand-alone module and comprises its own control elements. It is possible to connect or install this timer module in an electrical cooking appliance at a later time. Under certain circumstances, retrofitting is also possible, in which case the timer relay is connected into the power supply to the heating device or the electrical cooking appliance as a whole. The inventive embodiment may also comprise an additional timer display, for example, one or more seven-segment displays.

Preferably, the control elements may be touch switches. Capacitance touch switches, in particular, are an obvious option. Particularly favourably, the timer module is configured so as to be also separate from a control or separate from the operating mode switches and power adjustment switches of the electrical cooking appliance. One obvious solution is to arrange said timer module in its own housing which then comprises the mentioned functional units.

These and additional features are evident from the claims and also from the description and the drawings, whereby the individual features may be implemented by themselves or in a group in the form of sub-combinations in one embodiment of the invention and in other fields, and may represent advantageous embodiments that can be protected independently and for which independent protection is claimed here. The division of the application into subheadings and individual sections does not restrict the general validity of the statements made therein.

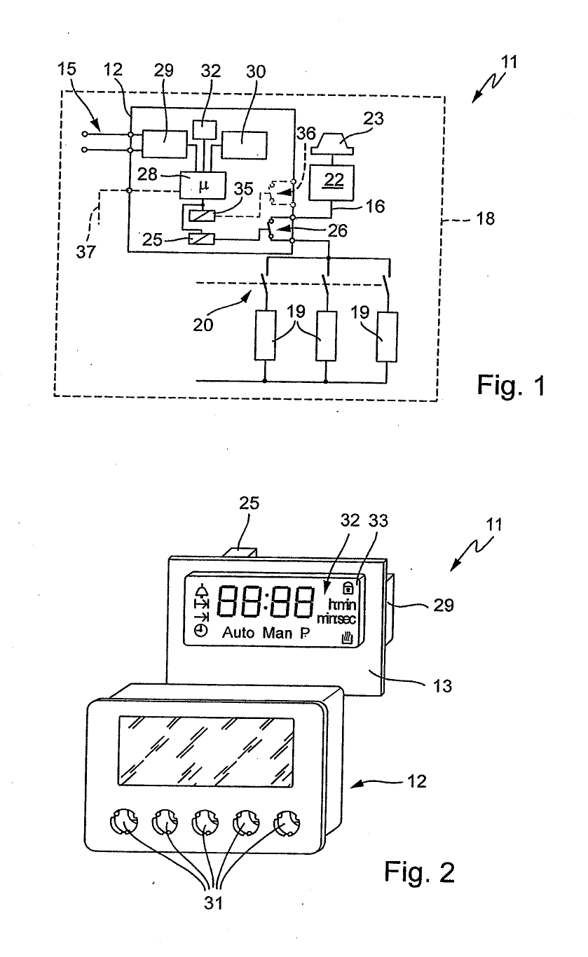

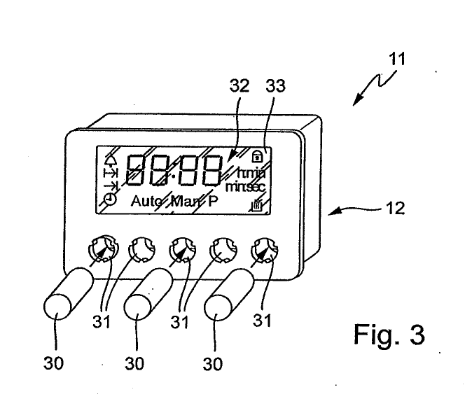

Turning now to the Figures, FIGS. 1 through 3, in particular the details of FIGS. 1 and 2, show a timer module 11 in accordance with the invention, i.e., in view of its function in FIG. 1, as well as in view of its design in FIGS. 2 and 3. The timer module comprises a housing 12, advantageously consisting of plastic material and having an upper transparent viewing window, in which a printed circuit board 13 with different components is installed.

FIG. 1 shows that the timer module 11 is connected to its own power connector 15, in particular for its own timer control 28, and that it is also connected to a power supply line 16 or is connected into the power supply line 16. When built in, the timer module 11 is part of an electrical cooking appliance 18 which, advantageously, is a baking oven with several heating devices 19 that may be configured as different baking oven heating devices. As can be seen, the timer module 11 is connected into the power supply line 16 of a power controller, said power controller being advantageously configured as a clocked power controlling device, toward the heating devices 19. The selection of the heating device 19 that is to be supplied with power via the power supply line 16 is made with a heat selector switch 20, which, like the power controller 22, is advantageously provided with a rotary toggle 23 and is arranged on the electrical cooking appliance 18 on a panel so as to be easily accessible. Thus, the power controller 22 defines the level of electrical power on the heating devices 19. The heat selector switch 20 defines which of the heating devices 19 is supplied with this power.

The timer module 11 comprises a timer relay 25 with a relay switch 26 that can be enabled by a timer control 28. It can be seen how, in accordance with the invention, the timer relay 25 is connected into the power supply line 16 in such a manner that the relay switch 28 is able to open the power supply line 16. This will be discussed in greater detail hereinafter. Furthermore, the timer module 11 comprises a power supply 29 and control elements 30.

Optionally, the timer module 11 may comprise a locking relay 35 with a relay switch 36 having connectors that are accessible from the outside, as well as with a temperature sensor connector 37. As previously mentioned, the temperature sensor connector 37 may be connected to a temperature sensor located in a baking oven chamber, and the temperature signal may be output to the timer control 28. This timer control may, depending on the temperature signal, open or close a lock for the oven door via a locking relay 35, including the relay switch 36, during the above-described pyrolysis mode. The mentioned display 32 of the timer module is advantageously configured as a multi-function display with a seven-segment display and various symbols, including, among others, the locking symbol 33. In addition, the housing 12 has housing openings 31 in which the cylindrical control elements 30 can be installed, said control elements being configured as so-called touch sensor elements in accordance with EP 859 457 A1. Then the entire timer module 11 may be mounted to the reverse side of a not illustrated baking oven panel in such a manner that the faces of the control elements 30 projecting from the housing 12 abut against the panel, and that the display 22 32 can be easily seen through the panel.

### Mode of Operation

The mode of operation of the timer module 11 comprising the timer relay 25 is as follows. Usually, the timer relay 25 comprising the relay switch 26 is closed, so that the electrical cooking appliance may be directly operated by means of the power controller 22 and the heat selector switch 20. If, in accordance with the aforementioned first basic embodiment of the invention, a timer setting is to be performed and then to be locked against change, the timer module 11 is first programmed with a specific switch-on time and switch-off time, this being possible via the control elements 30. After the timer setting has been completed, the safety locking function on the timer module may be activated by actuating one of the control elements 30 for 5 seconds, for example, and the timer module is locked. As a result of this, firstly, the timer relay 25 including the relay switch 26 is opened to successfully complete the setting of the timer, so that now the operating mode and the operating power can be set on the heat selector switch 20 and on the power controller 22, without the heating devices 19 heating already at this time. Secondly, the safety lock function prevents a change of the timer setting, so that any actuation of the control elements 30 remains without effect or is not registered as a control actuation. Only by actuating the same control element 30 for another 5 seconds, as is done to activate the safety lock function, is it possible to reverse the latter setting.

When the time set on the timer module is then reached, the timer relay 25, including the relay switch 26, closes and the pre-specified operating cycles of the electrical cooking appliance are performed. After the set time has elapsed, the timer relay 25 and the relay switch 26 open again and the electrical cooking appliance is again stopped. Even if, before timer operation, during timer operation or after timer operation, changes are performed on the heat selector switch 20 and on the power controller 22, this does not change anything regarding the pre-specified time cycles, even though, of course, the power could be set unintentionally high by means of the power controller 22.

In order to be able to reuse the electrical cooking appliance upon completion of the timer mode or in order to reverse the safety lock function, the same control element 30, as before, is again actuated for 5 seconds.

In accordance with the second aforementioned basic embodiment of the invention, the safety lock function is to be activated directly as a general child safety feature. To do so, the same control element as previously mentioned is actuated for 5 seconds, thus effecting an opening of the timer relay 25 with the relay switch 26, and thus preventing an operation of the heating devices 19. Any adjustments on the heat selector switch 20 and on the power controller 22 are not able to change anything regarding this. This is a type of permanent lock.

For the aforementioned pyrolysis function, a temperature sensor of the baking oven chamber is connected to the temperature sensor connector 37. If, as a result of this or due to the extremely high temperature detected by the temperature sensor in the baking oven chamber, the pyrolysis function is detected, the locking relay 35 with the relay switch 36 can activate a not specifically illustrated door lock of the baking oven door—which, however, is known to those skilled in the art—at a temperature, for example 250° C., that is viewed as being critical, so that the baking oven door cannot be opened. Only after the completion of the pyrolysis cycle when the timer control 28 reports as detected—via the temperature sensor connector 37—a drop of the temperature below the critical temperature, will the locking relay 35 and the relay switch 36 be opened, so that the baking oven door can be opened again.

Consequently, the invention provides a timer module that can either lock the user's timer setting or, if such a setting has not been entered, the entire electrical cooking appliance or its heating devices against prevents adjustment or unauthorized activation, this being accomplished via an integral timer relay 25, depending on the circumstances also the described locking relay, and a safety lock function programmed into a timer control 28. Even though this will not exclude each and every error event, at least a clearly higher degree of safety is achieved.

1. A method for controlling an electrical cooking appliance comprising an integrated heating device, whereby the electrical cooking appliance comprises a timer module with a timer relay, a switch for operating mode selection and a switch for setting a heating temperature or a heating power, whereby the timer relay is arranged in a power supply line to the heating device, comprising the steps of:
activating a first safety lock function on the timer module by a special user function,
locking a timer setting against change after activation of said first safety lock, so that an operating cycle of the electrical cooking appliance takes place as intended, said operating cycle being prespecified in the timer module by the user setting the timer; and
thereafter, the heating device or the electrical cooking appliance is switched off by opening the timer relay, whereby the timer relay is designed in such a manner that it can only be reactivated or closed by activating an additional special user function on the timer module.

2. A method for controlling an electrical cooking appliance comprising an integrated heating device, whereby the electrical cooking appliance comprises a timer module with a timer relay, a switch for operating mode selection and a switch for setting a heating temperature or a heating power, whereby the timer relay is arranged in a power supply line to the heating device, comprising the steps of:
activating a second safety lock on the timer module by a special user function; and
following the activation of the second safety lock, the timer relay opening in order to prevent an operation of the heating device or the electrical cooking appliance, whereby the timer relay is designed in such a manner that it can only be reactivated or closed by activating an additional special user function on the timer module.

3. The method in accordance with claim 2, characterized in that, only due to a deactivation of the safety lock, the timer relay is closed or activated for operating the electrical cooking appliance in any desired mode.

4. The method in accordance with claim 1, characterized in that the first safety lock function can be activated in the same manner or by the same activation, whereby depending on whether a timer mode has been pre-specified, the first safety lock function is activated in such a manner that, with the timer mode pre-specified, the first safety lock function is activated, and that otherwise a second safety lock function is activated.

5. The method in accordance with claim 1, characterized in that the first safety lock function secures a time function set in the timer module against change or readjustment.

6. The method in accordance with claim 5, characterized in that the first safety lock function is activated by a user function of the group comprising one of the following:
simultaneous actuation of several control elements;
sequential actuation of several user elements in an exactly prescribed sequence; and
actuation of at least one control element.

7. The method in accordance with claim 1, characterized in that an activated safety lock function is indicated as an illuminated symbol on a display on the timer module or on the electrical cooking appliance.

8. The method in accordance with claim 7, characterized in that an activated safety lock function is indicated as an illuminated symbol on a display on the timer module or on the electrical cooking appliance, without difference between the first and the second safety lock functions.

9. The method in accordance with claim 1, characterized in that, with the safety lock function activated, it is only possible to resume operation of the electrical cooking appliance or change the continued operation of the electrical cooking appliance by means of a specific user function.

10. The method in accordance with claim 9, characterized in that the special user function is the same as the one for the activation of the safety lock function.

11. The method in accordance with claim 1, characterized in that, following a first or renewed connection of the electrical cooking appliance to the power supply or after a power failure, the safety lock function is automatically activated by opening the timer relay and that, only after deactivation by a special user function, the electrical cooking appliance will be again ready for operation.

12. The method in accordance with claim 1, characterized in that the electrical cooking appliance is a baking oven with a baking oven chamber and with a baking oven heating device as the heating device, as well as with a pyrolysis function for cleaning the baking oven chamber of the baking oven by means of the baking oven heating device, whereby an additional locking relay for the pyrolysis function is provided for locking a door lock of the baking oven and is integrated in or is a part of the timer module.

13. The method in accordance with claim 1, characterized in that the timer module has another input connector for a temperature sensor in the baking oven chamber, and whereby, depending on the temperature, a door lock is opened or the locking relay is actuated via this input connector.

14. A timer module configured to activate a first safety lock function of the timer module by activation of a special user function, said time module further configured to lock a timer setting against change activation of said first safety lock function, wherein said timer module is configured for a user to set the timer for a pre-specified operating cycle of an electrical cooking appliance, wherein the timer module is a stand-alone module, said timer module comprising:
control elements;
a timer relay configured to be reactivated or closed by activating an additional special user function of the timer module;
a timer display, and
connectors to serially connect the timer relay into a power supply to the heating device of the electrical cooking appliance, wherein said electrical cooking appliance comprises a heating device that is configured to be switched off by opening the timer relay.

15. The timer module in accordance with claim 14, characterized in that the control elements of the timer module are capacitatively operating touch switches.

16. The timer module in accordance with claim 14, characterized in that the timer module is designed as to be separate from a control or from operating mode switches and power setting switches of the electrical cooking appliance.

17. The timer module in accordance with claim 14, characterized in that the electrical cooking appliance is a baking oven with a baking oven chamber and a baking oven heating device as the heating device, as well as with a pyrolysis function for cleaning the baking oven chamber by the baking oven heating device, whereby the timer module comprises another locking relay for the pyrolysis function for locking a door lock.

18. The timer module in accordance with claim 17, characterized in that the timer module has an additional input connector for a temperature sensor in the baking oven chamber.
